(19) United States
(12) Patent Application Publication
(10) Pub. No.: US 2011/0106444 A1
(43) Pub. Date: May 5, 2011

(54) MOBILE OBJECT POSITION DETECTING DEVICE

(75) Inventors: Akito Adachi, Shizuoka (JP); Yuki Yamada, Shizuoka (JP)

(73) Assignee: Toyota Jidosha Kabushiki Kaisha, Toyota-shi, AICHI (JP)

(21) Appl. No.: 13/001,555

(22) PCT Filed: Feb. 19, 2009
(86) PCT No.: PCT/JP2009/052908

§ 371 Date: Dec. 27, 2010

(51) Int. Cl. G01C 21/30

(52) U.S. Cl. 701/208

(57) ABSTRACT

A mobile object position detecting device 1 which matches the position of another vehicle existing in a predetermined region to the map information regarding the predetermined region includes: a vehicle-to-vehicle communication unit 2 which receives the positional information and the moving state information regarding another vehicle; a road-to-vehicle communication unit 3 which acquires the road environment information including the road environment in the predetermined region; a determination section 4a which determines whether or not a traveling state of another vehicle complies with the road environment; and a matching section 4b which matches the position of another vehicle to the map information according to a result of the determination by the determination section 4a. Accordingly, the mobile object position detecting device capable of precisely matching the position of a mobile object to the map information is provided.

### TECHNICAL FIELD

The present invention relates to a mobile object position detecting device which matches the position of a mobile object existing in a predetermined region to the map information regarding the predetermined region.

### BACKGROUND ART

In the above-described field, for example, a technique disclosed in Patent Document 1 is known. In the map display method of a navigation apparatus disclosed in Patent Literature 1, when a vehicle approaches an intersection or the like, the surrounding vehicle information is acquired through vehicle-to-vehicle communication and the surrounding vehicle information collection region is displayed in an enlarged manner and the surrounding vehicle is also displayed at the existing location.
Patent Literature 1: Japanese Unexamined Patent Application Publication No. 2004-077281

### SUMMARY OF INVENTION

### Technical Problem

In such a map display method, generally, the positions of mobile objects including the vehicle and other vehicles are measured by a GPS and the positions of the mobile objects are matched to the road of the map information. For this reason, if an error occurs in the GPS or the map information, the position of the mobile object may be matched to the wrong road.

Therefore, the present invention has been made in view of such a situation, and it is an object of the present invention to provide a mobile object position detecting device capable of precisely matching the position of a mobile object to the map information.

### Solution to Problem

In order to achieve the above-described object, a mobile object position detecting device related to the present invention is a mobile object position detecting device which matches the position of a mobile object existing in a predetermined region to the map information regarding the predetermined region and is characterized in that it includes: a receiving means for receiving the positional information and the moving state information regarding the mobile object; an acquisition means for acquiring the road environment information in the predetermined region; and a matching means for matching the position of the mobile object to the map information on the basis of the positional information, the moving state information, and the road environment information.

In this mobile object position detecting device, when matching the position of a mobile object to the map information, the road environment information is further used in addition to the positional information and the moving state information. Accordingly, it is possible to precisely match the position of a mobile object to the map information.

Moreover, in the mobile object position detecting device related to the present invention, it is preferable that the mobile object position detecting device is mounted in a vehicle, the mobile object is another vehicle, and the moving state information includes a traveling state of the another vehicle. In this case, it is possible to precisely match the position of the another vehicle on the basis of the traveling state.

Moreover, in the mobile object position detecting device related to the present invention, it is preferable to further include a determination means for determining whether or not the traveling state complies with the road environment included in the road environment information, and it is preferable that the matching means matches the position of the another vehicle to the map information according to a result of the determination by the determination means. In this case, since the matching means matches the position of the another vehicle to the map information according to the determination result of the determination means, it is possible to more precisely match the position of the another vehicle to the map information.

Moreover, in the mobile object position detecting device related to the present invention, it is preferable that, when the determination means determines that the traveling state does not comply with the road environment, the matching means matches the position of the another vehicle to a road, which is adjacent to the position of the another vehicle in the map information and which has the road environment that the traveling state complies with. In this case, the matching means can match the position of the another vehicle on the appropriate road included in the map information.

Moreover, in the mobile object position detecting device related to the present invention, it is preferable that the road environment includes the existence of a stop sign, a signal state, and a speed limit. In this case, the determination means can easily perform determination regarding whether or not the traveling state of the another vehicle complies with the road environment using the existence of a stop sign, the signal state, and the speed limit.

Moreover, in the mobile object position detecting device related to the present invention, it is preferable that the traveling state includes a speed of the another vehicle. In this case, the determination means can easily perform determination regarding whether or not the traveling state of the another vehicle complies with the road environment using the speed of the another vehicle.

Moreover, in the mobile object position detecting device related to the present invention, it is preferable that the determination means determines that the traveling state does not comply with the road environment when the another vehicle does not stop at the stop sign and when the speed of the another vehicle is higher than the speed limit by a predetermined value. In this case, the determination means can easily and precisely perform determination regarding whether or not the traveling state of the another vehicle complies with the road environment using the existence of a stop sign, the signal state, the speed limit, and the speed of the another vehicle.

Moreover, in the mobile object position detecting device related to the present invention, it is preferable that the traveling state includes the acceleration and the lighting state of a blinker of the another vehicle. In this case, the determination means can easily perform determination regarding whether or not the traveling state of the another vehicle complies with the road environment using the acceleration and the lighting state of a blinker of the another vehicle.

Moreover, in the mobile object position detecting device related to the present invention, it is preferable that the positional information is created by measuring the position of the another vehicle with a GPS and the receiving means receives the positional information and the moving state information from the another vehicle through vehicle-to-vehicle communication between the vehicle and the another vehicle. In this case, the positional information and the moving state information can be easily received through the vehicle-to-vehicle communication.

Moreover, in the mobile object position detecting device related to the present invention, it is preferable that the acquisition means acquires the road environment information from a transmitter, which is provided in the predetermined region, through road-to-vehicle communication with the transmitter. In this case, the road environment information can be easily acquired through the road-to-vehicle communication.

Moreover in the mobile object position detecting device related to the present invention, it is preferable to further include a display means for displaying the map information with positional information which is created by matching the position of the mobile object to the map information. In this case, the driver of the vehicle can easily recognize the position of the another vehicle matched to the map information.

### ADVANTAGEOUS EFFECTS OF INVENTION

According to the present invention, it is possible to provide a mobile object position detecting device capable of precisely matching the position of a mobile object to the map information.

### BRIEF DESCRIPTION OF DRAWINGS

FIG. 1 is a block diagram showing the configuration of an embodiment of a mobile object position detecting device related to the present invention.

FIG. 2 is a view for explaining a first use example of the mobile object position detecting device shown in FIG. 1.

FIG. 3 is a view for explaining a second use example of the mobile object position detecting device shown in FIG. 1.

FIG. 4 is a view for explaining a third use example of the mobile object position detecting device shown in FIG. 1.

### REFERENCE SIGNS LIST

1: mobile object position detecting device
2: vehicle-to-vehicle communication unit (receiving means)
3: road-to-vehicle communication unit (acquisition means)
4: ECU
4a: determination section (determination means)
4b: matching section (matching means)
5: display section (display means)

### DESCRIPTION OF EMBODIMENTS

Hereinafter, preferred embodiments of the present invention will be described with reference to the drawings. Moreover, in each drawing, the same or corresponding sections are denoted by the same reference numerals and repeated explanation will be omitted.

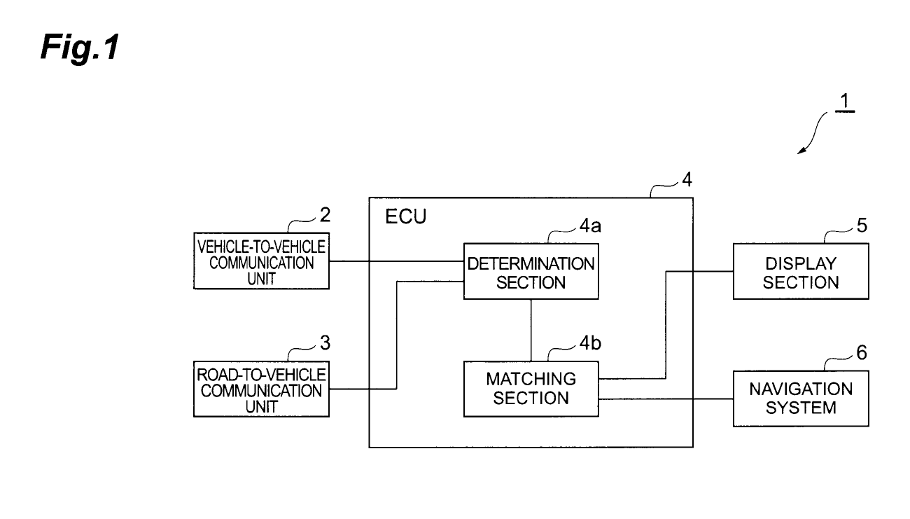

FIG. 1 is a block diagram showing the configuration of an embodiment of a mobile object position detecting device related to the present invention. As shown in FIG. 1, a mobile object position detecting device 1 includes a vehicle-to-vehicle communication unit (receiving means) 2, a road-to-vehicle communication unit (receiving means) 3, an ECU (Electronic Control Unit) 4, a display section (display means) 5, and a navigation system 6. In addition, the ECU 4 includes a determination section (determination means) 4a and a matching section (matching means) 4b. In the present embodiment, the mobile object position detecting device 1 is mounted in a vehicle.

The vehicle-to-vehicle communication unit 2 is a transceiver for transmission and reception of information between vehicles. The vehicle-to-vehicle communication unit 2 receives positional information, which is created by positioning using a GPS and the like by another vehicle, from another vehicle and transmits it to the determination section 4a of the ECU 4. In addition, the vehicle-to-vehicle communication unit 2 receives from another vehicle the moving state information including traveling states, such as the speed and acceleration of another vehicle and the lighting state of a blinker, and transmits it to the determination section 4a.

The road-to-vehicle communication unit 3 is a receiver for receiving the information from a transmitter, such as a light beacon provided on the road. The road-to-vehicle communication unit 3 receives and acquires the road environment information from the transmitter, such as a light beacon, and transmits it to the determination section 4a of the ECU 4. Here, the road environment information is information including the road environment, such as whether or not there is a stop sign on a predetermined road, the signal state, and the speed limit.

The ECU 4 is configured to include an operational device such as a CPU, storage devices such as a ROM and a RAM, a communication module, and the like which are not shown in the drawing. They work together to realize functions of the determination section 4a and the matching section 4b.

The determination section 4a determines whether or not the traveling state of another vehicle complies with the road environment of the road where another vehicle travels and transmits the information regarding the determination result to the matching section 4b. Specifically, the determination section 4a determines whether or not the traveling state of another vehicle complies with the environment of the road, on which another vehicle travels, on the basis of whether or not another vehicle has stopped at the stop sign and whether or not the speed of another vehicle is higher than the speed limit by a predetermined value or more and transmits the information regarding the determination result to the matching section 4b.

The matching section 4b matches the position of another vehicle to the map information regarding a predetermined region transmitted from the navigation system 6, which will be described later, according to the determination result transmitted from the determination section 4a. That is, when the matching section 4b receives from the determination section 4a the information indicating that the traveling state of another vehicle does not comply with the road environment of the road where another vehicle travels, the matching section 4b matches the position of another vehicle on the road, which is adjacent to the position of another vehicle in the map information and has a road environment for which the traveling state of another vehicle complies with. Then, the matching section 4b transmits the map information with positional information, which is created by matching the position of another vehicle to the map information, to the display section 5.

The display section 5 outputs to a display or the like (not shown in the drawing) the map information with positional information transmitted from the matching section 4b and displays it.

The navigation system 6 has a GPS receiving section (not shown in the drawing), which detects the position of the vehicle by receiving an electric wave from a plurality of GPS (Global Positioning System) satellites, and map information in which road structures, positions of facilities, and the like are stored. The navigation system 6 transmits the map information regarding a predetermined region, which includes a road on which the vehicle is traveling, to the matching section 4b on the basis of the position of the vehicle and the map information.

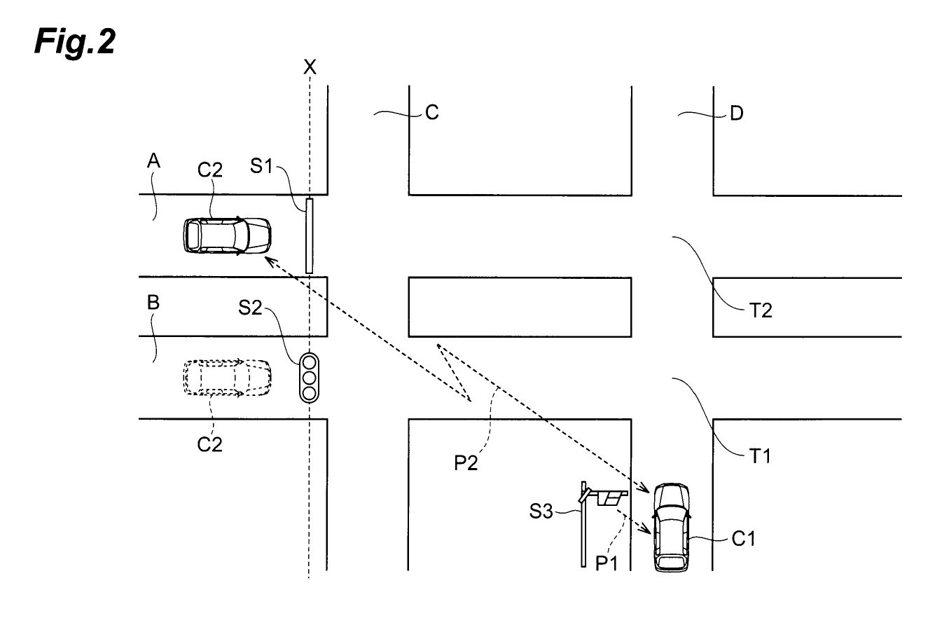

Next, a first use example of the mobile object position detecting device 1 will be described using FIG. 2. FIG. 2 shows the map information regarding a predetermined region. As shown in FIG. 2, a vehicle C1 in which the mobile object position detecting device 1 is mounted is traveling on the road D and is approaching an intersection T1 between the road B and the road D and an intersection T2 between the road A and the road D. In this case, in order to prevent the collision of the vehicle C1 and another vehicle C2, it is desirable to detect beforehand at which intersection of the intersection T1 and the intersection T2 the vehicle C1 and another vehicle C2 will meet.

A light beacon S3 is provided on the road D where the vehicle C1 is traveling. The road A and the road B are adjacent to each other. On the road A, a stop sign S1 is provided at the position X. On the road B, a traffic signal S2 is provided at the position X.

The vehicle-to-vehicle communication unit 2 of the vehicle C1 receives the moving state information P2 on another vehicle C2 from another vehicle C2 through vehicle-to-vehicle communication and transmits the information to the determination section 4a. The information regarding the traveling states, such as the speed and acceleration of another vehicle C2, is included in the moving state information P2.

The road-to-vehicle communication unit 3 of the vehicle C1 receives the road environment information P1 on the road A and the road B from the light beacon S3 through road-to-vehicle communication and transmits the information to the determination section 4a. The information regarding the stop sign S1 provided on the road A and the information regarding the signal state of the traffic signal S2 provided on the road B are included in the road environment information P1.

When another vehicle C2 slows down or stops at the position X even though the traffic signal S2 on the road B is green, the determination section 4a of the vehicle C1 determines that the traveling state of another vehicle C2 does not comply with the road environment of the road B and transmits the information regarding the determination result to the matching section 4b.

According to the determination result, the matching section 4b of the vehicle C1 matches the position of another vehicle C2 on the road A which is a road on the map information, which is adjacent to the road B, and which is suitable for the traveling state of another vehicle C2 which slows down or stops at the position X. As a result, it is detected that another vehicle C2 is traveling on the road A. Accordingly, the vehicle C1 detects beforehand that the vehicle C1 and another vehicle C2 may meet at the intersection T2.

Then, the matching section 4b transmits the map information with positional information, which is created by matching the position of another vehicle C2 to the map information, to the display section 5, and the display section 5 displays the information on a display. Accordingly, the driver of the vehicle C1 recognizes beforehand that the vehicle C1 may meet another vehicle C2 at the intersection T2, so that a collision between the fronts of the vehicles can be avoided. In addition, when the road A and the road B are congested, it is difficult to perform the above-described determination. In this case, it is possible to acquire the congestion information beforehand from a VICS center or the like and to determine whether or not to perform the above-described determination.

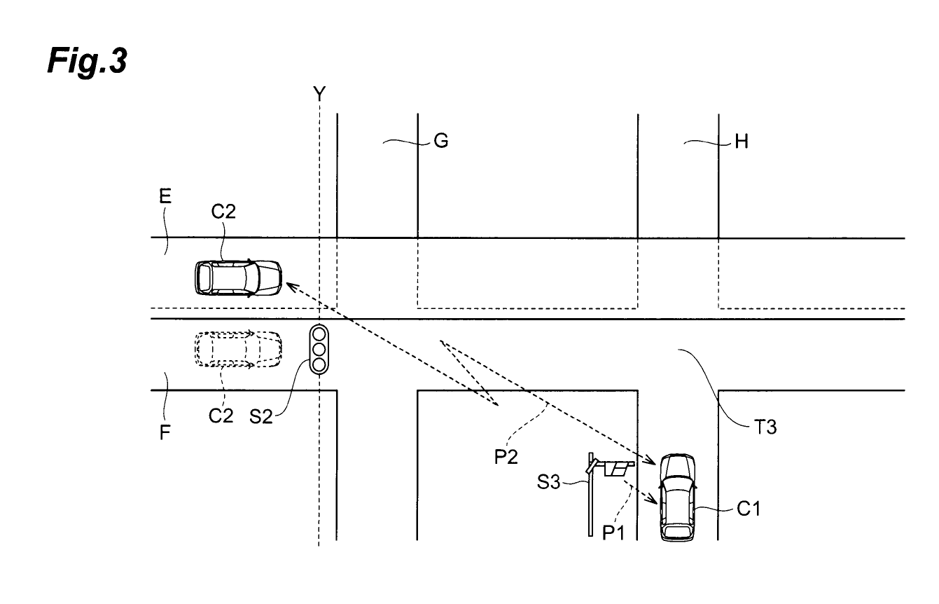

Next, a second use example of the mobile object position detecting device 1 will be described using FIG. 3. FIG. 3 shows the map information regarding a predetermined region. As shown in FIG. 3, the vehicle C1 in which the mobile object position detecting device 1 is mounted is traveling on the road H and is approaching an intersection T3. The road E is an overpass, such as a freeway, and is constructed on the road F. Accordingly, the road E and the road F are adjacent to each other. On the road F, the traffic signal S2 is provided at the position Y. On the road H, the light beacon S3 is provided.

The vehicle-to-vehicle communication unit 2 of the vehicle C1 receives the moving state information P2 on another vehicle C2 from another vehicle C2 through vehicle-to-vehicle communication and transmits the information to the determination section 4a. The information regarding the traveling states, such as the speed and acceleration of another vehicle C2, is included in the moving state information P2.

The road-to-vehicle communication unit 3 of the vehicle C1 receives the road environment information P1 on the road E and the road F from the light beacon S3 through road-to-vehicle communication and transmits the information to the determination section 4a. The information regarding the speed limits of the road E and the road F and the information regarding the signal state of the traffic signal S2 provided on the road F are included in the road environment information P1.

When another vehicle C2 does not slow down or stop at the position Y even though the traffic signal S2 on the road F is red, the determination section 4a of the vehicle C1 determines that the traveling state of another vehicle C2 does not comply with the road environment of the road F and transmits the information regarding the determination result to the matching section 4b. In addition, when the speed of another vehicle C2 is higher than the speed limit of the road F by a predetermined value or more even if the traffic signal S2 on the road F is green, the determination section 4a determines that the traveling state of another vehicle C2 does not comply with the road environment of the road F and transmits the information regarding the determination result to the matching section 4b.

According to the determination result, the matching section 4b of the vehicle C1 matches the position of another vehicle C2 on the road F which is a road on the map information, which is adjacent to the road F, and which is suitable for the traveling state of another vehicle C2 which does not slow down or stop at the position Y. Alternatively, according to the determination result, the matching section 4b matches the position of another vehicle C2 to the road E which is a road on the map information, which is adjacent to the road F, and on which traveling in a speed higher than the speed limit of the road F by a predetermined value or more is possible. As a result, it is detected that another vehicle C2 is traveling on the road E. Accordingly, the vehicle C1 detects beforehand that the vehicle C1 and another vehicle C2 will not meet at the intersection T3 because another vehicle C2 is traveling on the overpass (road E). Then, the matching section 4b transmits the map information with positional information, which is created by matching the position of another vehicle C2 to the map information, to the display section 5, and the display section 5 displays the information on a display.

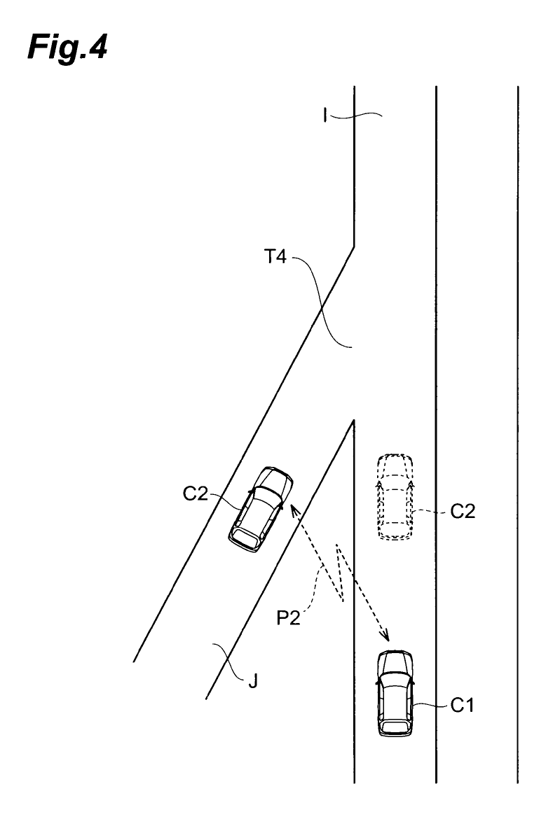

Next, a third use example of the mobile object position detecting device 1 will be described using FIG. 4. FIG. 4 shows the map information regarding a predetermined region. As shown in FIG. 4, a vehicle C1 in which the mobile object position detecting device 1 is mounted is traveling on the road I and is approaching a merge point T4 between the road I and the merged road J which is merged into the road I.

The vehicle-to-vehicle communication unit 2 of the vehicle C1 receives the moving state information P2 on another vehicle C2 from another vehicle C2 through vehicle-to-vehicle communication and transmits the information to the determination section 4a. The information regarding the traveling states, such as the acceleration of another vehicle C2 and the lighting state of the blinker, is included in the moving state information P2.

When the acceleration of another vehicle C2 is equal to or larger than a predetermined value and a blinker on the right side is turned on, the determination section 4a of the vehicle C1 determines that the traveling state of another vehicle C2 does not comply with the road environment of the road I and transmits the information regarding the determination result to the matching section 4b.

According to the determination result, the matching section 4b of the vehicle C1 matches the position of another vehicle C2 to a road (to the merged road J) which is a road on the map information, which is adjacent to the road I, and which is suitable for the traveling state of another vehicle C2 which has an acceleration equal to or larger than a predetermined value and in which a blinker on the right side is turned on. As a result, it is detected that another vehicle C2 is traveling on the merged road J. Accordingly, the vehicle C1 detects beforehand that the vehicle C1 and another vehicle C2 may meet at the merge point T4. Then, the matching section 4b transmits the map information with positional information, which is created by matching the position of another vehicle C2 to the map information, to the display section 5, and the display section 5 displays the information on a display. Accordingly, the driver of the vehicle C1 recognizes beforehand that the vehicle C1 may meet another vehicle C2 at the merge point T4, so that a collision between the fronts of the vehicles can be avoided. In addition, the mobile object position detecting device 1 mounted in the vehicle C1 in the third use example may be configured not to include the road-to-vehicle communication unit 3. In this case, the mobile object position detecting device 1 of the vehicle C1 acquires the road environment information from the navigation system 6 or the like.

As described above, in the mobile object position detecting device 1 related to the present embodiment, the road environment information is further used in addition to the positional information and the moving state information when matching the position of another vehicle to the map information. Accordingly, it is possible to precisely match the position of another vehicle to the map information. Moreover, in the mobile object position detecting device 1, the matching means matches the position of another vehicle to the map information according to the determination result of the determination means. Accordingly, it is possible to precisely match the position of another vehicle to the map information. Moreover, in the mobile object position detecting device 1, the determination means can easily perform determination regarding whether or not the traveling state of another vehicle complies with the road environment using the existence of a stop sign, a signal state, the speed limit, the speed of another vehicle, the acceleration of another vehicle, a lighting state of a blinker, and the like. Moreover, in the mobile object position detecting device 1, the positional information, the moving state information, and the road environment information can be easily received through the vehicle-to-vehicle communication and the road-to-vehicle communication. Moreover, in the mobile object position detecting device 1, the driver of the vehicle can easily recognize the position of another vehicle matched to the map information.

Moreover, although the mobile object position detecting device 1 is mounted in a vehicle in the present embodiment, it is not limited to this. For example, the mobile object position detecting device 1 may also be used in a state of being mounted in portable terminals, such as a mobile phone, a PDA, and a notebook computer. In addition, the mobile object position detecting device 1 may also be installed and used at a predetermined position on the road. In this case, the display section 5 of the mobile object position detecting device 1 can output the map information with positional information transmitted from the matching section 4b to a display or the like, which is installed on the road, and display it.

### INDUSTRIAL APPLICABILITY

According to the present invention, it is possible to provide a mobile object position detecting device capable of precisely matching the position of a mobile object to the map information.

1. A mobile object position detecting device which matches the position of a mobile object existing in a predetermined region to map information regarding the predetermined region, comprising:
a receiving means for receiving positional information and moving state information regarding the mobile object;
an acquisition means for acquiring road environment information in the predetermined region; and
a matching means for matching the position of the mobile object to the map information on the basis of the positional information, the moving state information, and the road environment information,
wherein the road environment information includes information indicating the existence of a stop sign, a signal state, and a speed limit on a road in the predetermined region.

2. The mobile object position detecting device according to claim 1,
wherein the mobile object position detecting device is mounted in a vehicle, and
the mobile object is another vehicle, and the moving state information includes a traveling state of the another vehicle.

3. The mobile object position detecting device according to claim 2, further comprising:
a determination means for determining whether or not the traveling state complies with the road environment included in the road environment information,
wherein the matching means matches the position of the another vehicle to the map information according to a result of the determination by the determination means.

4. The mobile object position detecting device according to claim 3,
wherein, when the determination means determines that the traveling state does not comply with the road environment, the matching means matches the position of the another vehicle to a road, which is adjacent to the position of the another vehicle in the map information and which has the road environment that the traveling state complies with.

5. (canceled)

6. The mobile object position detecting device according to claim 4, wherein the traveling state includes a speed of the another vehicle.

7. The mobile object position detecting device according to claim 6, wherein the determination means determines that the traveling state does not comply with the road environment when the another vehicle does not stop at the stop sign and when the speed of the another vehicle is higher than the speed limit by a predetermined value.

8. The mobile object position detecting device according to claim 2, wherein the traveling state includes acceleration and a lighting state of a blinker of the another vehicle.

9. The mobile object position detecting device according to claim 2,
wherein the positional information is created by measuring the position of the another vehicle with a GPS, and
the receiving means receives the positional information and the moving state information from the another vehicle through vehicle-to-vehicle communication between the vehicle and the another vehicle.

10. The mobile object position detecting device according to claim 2, wherein the acquisition means acquires the road environment information from a transmitter, which is provided in the predetermined region, through road-to-vehicle communication between the vehicle and the transmitter.

11. The mobile object position detecting device according to claim 1, further comprising:
a display means for displaying map information with positional information which is created by matching the position of the mobile object to the map information.
